(19) United States
(12) Patent Application Publication
(10) Pub. No.: US 2013/0198454 A1
(43) Pub. Date: Aug. 1, 2013

(54) CACHE DEVICE FOR CACHING

(71) Applicant: Fraunhofer-Gesellschaft zur Foerderung der angewandten Forschung e.V., Munich (DE)

(72) Inventors: Heiko SPARENBERG, Nuernberg (DE); Siegfried FOESSEL, Erlangen (DE); Florian SCHLEICH, Bamberg (DE); Matthias MARTIN, Erlangen (DE)

(73) Assignee: Fraunhofer-Gesellschaft zur Foerderung der angewandten Forschung e.V., Munich (DE)

(21) Appl. No.: 13/720,152

(22) Filed: Dec. 19, 2012

Related U.S. Application Data
(60) Provisional application No. 61/579,352, filed on Dec. 22, 2011.

(30) Foreign Application Priority Data
Feb. 2, 2012 (DE) 102012201530.2

(51) Int. Cl. G06F 12/08

(52) U.S. Cl. CPC G06F 12/0802
USPC 711/118

(57) ABSTRACT

A cache device for caching scalable data structures in a cache memory exhibits a displacement strategy, in accordance with which scaling-down of one or more scalable files in the cache memory is provided for the purpose of freeing up storage space.

### CROSS-REFERENCE TO RELATED APPLICATIONS

This application claims priority from German Patent Application No. 102012201530.2, which was filed on Feb. 2, 2012, and from U.S. Patent Application No. 61/579,352, which was filed on Dec. 22, 2011, both of which are incorporated herein in their entirety by reference.

Embodiments of the present invention relate to a cache device for caching files and to a method of managing a cache memory of a cache device, as well as to a computer program.

### BACKGROUND OF THE INVENTION

A cache memory is utilized for caching files, e.g. media files such as audio or video files, for example, and to have them ready for a decoder, for example. This offers the advantage that the files, which typically consist of individual information packets, may be more rapidly provided to the decoder or to a CPU (central processing unit) or GPU (graphics processing unit), on which the decoding software is executed, which in most cases is a prerequisite for enabling real-time reproduction of the media file. Such media files, such as JPEG 2000 files, H.264 files or MPEG4 files, however, are typically very large, so that a cache memory may be completely filled up after having stored few such media files.

In order to free up the cache memory again and to thus reserve storage space for other applications or for storing other media files, different strategies may be employed. A strategy frequently utilized here is the so-called FIFO (first in and first out) strategy, wherein the file that was the first to be read in will be the first to be discarded, and/or wherein the storage locations utilized for said file are marked as having been freed up. Another strategy frequently used is the so-called LRU strategy (least recently used), wherein the file which has not been accessed for the longest period of time is released. In accordance with the LFU strategy (least frequently used), those files which have been least frequently accessed may be released. However, said three strategies or methods of freeing up storage space have in common that it is invariably the complete file and/or all of the information packets (data block) belonging to said file that are completely removed from the cache memory (cache).

Upon repeated access to the discarded file, the complete file will consequently have to be read in again from the mass storage medium and be cached. When a previously stored, but subsequently discarded file is repeatedly called up, this will cause considerable and, in most cases, unnecessary buffering times. Consequently, the freeing-up strategy selected is very important. However, when using the above-described methods, selection of the file to be discarded is often difficult, in particular when few very large files or several large files of a set of files which belong together are stored in the cache memory. Therefore, there is the need for an improved approach to managing the cache memory.

### SUMMARY

According to an embodiment, a cache device for caching files in a cache memory may have a replacement strategy according to which scaling-down of one or more scalable files in the cache memory is provided in order to free up storage space.

According to another embodiment, a method of managing a cache memory of a cache device may have the step of freeing up storage space in accordance with a displacement strategy, in accordance with which scaling-down of one or more scalable files in the cache memory is provided for caching.

According to another embodiment, a computer program may have a program code for performing the method of managing a cache memory of a cache device, which method may have the step of freeing up storage space in accordance with a displacement strategy, in accordance with which scaling-down of one or more scalable files in the cache memory is provided for caching, when the program runs on a computer.

Embodiments of the present invention provide a cache device for caching files in a cache memory, the cache device exhibiting a displacement strategy, according to which scaling-down of one or more scalable files in the cache memory is provided in order to free up storage space.

It is the core idea of the present invention that it should be possible to make better use of a cache memory by selectively releasing only individual parts of the one or more scalable files, namely individual information packets. Scalable files, which typically comprise an information packet of a basic information level and information packets of a non-basic information level, offer the possibility of discarding, during execution, the information packets of the non-basic information level. Due to the missing information packets of the non-basic information level, the level of detail, e.g. a resolution or a quality (in a scalable media file) is admittedly reduced, the file per se nevertheless remaining representable. This property may be exploited in the displacement strategy. Here, the information packets of the non-basic information level are released in a targeted manner and are replaced with empty information packets when they are being output. Consequently, one may achieve that the cached file may be directly representable, i.e. without any previous buffering, upon repeated access to same, and that, at the same time, it was possible to free up the storage space that may be used.

In accordance with further embodiments, different displacement strategies may be applied here, so that different information packets of non-basic information levels are replaced with empty information packets. Advantageously, freeing-up of storage space is effected such that storage occupancy by an empty or incompletely stored information packet is freed up. In accordance with further embodiments, freeing-up of storage space is effected such that, first of all, the storage locations of such an information packet are freed up which comprises information of a most detailed extension information level.

In accordance with further embodiments, it is also possible to log a freeing-up status when freeing up the storage space. Said freeing-up status serves the purpose of being able to repeatedly reload the discarded information packets or of replacing, during output, the discarded information packets with empty information packets so that the scalable file is output in that structure in which it is expected by the calling application.

### BRIEF DESCRIPTION OF THE DRAWINGS

Embodiments of the present invention will be detailed subsequently referring to the appended drawings, in which:

FIG. 1 shows a schematic representation of a device for caching a scalable original file by means of an integrated cache device;

FIG. 2 shows a schematic representation of a scalable file;

FIGS. 3a-3c show schematic illustrations of the process of reloading or repeatedly calling up (polling) a scalable image file;

FIG. 4 shows a schematic representation of a data stream for two successive frames of a moving image sequence;

FIG. 5 shows a schematic representation of a cache device for caching in accordance with an embodiment; and

FIGS. 6a-6c show schematic diagrams of data throughput rates when using the device for caching in different juxtapositions.

### DETAILED DESCRIPTION OF THE INVENTION

Before embodiments of the present invention will be explained in more detail below with reference to the accompanying figures, it shall be pointed out that identical elements or elements having identical actions are provided with identical reference numerals, so that the descriptions of same are interchangeable or may be mutually applied.

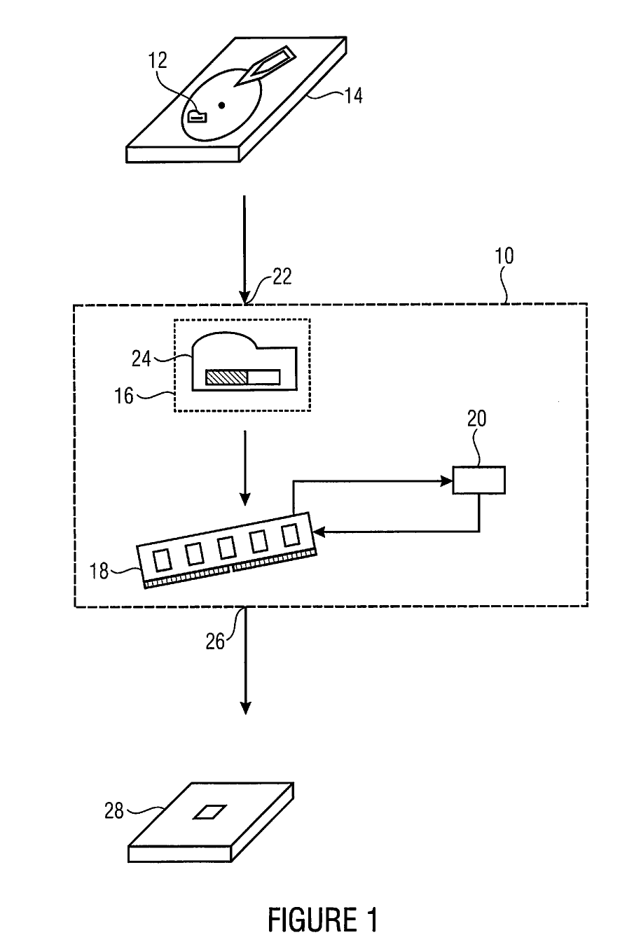

FIG. 1 shows a device 10 for caching a scalable original file 12 which is stored, e.g., on a mass storage medium 14 such as a hard disk or any other physical medium. The device 10 for caching includes a proxy file generator 16 and a cache memory 18 as well as the optional cache device 20. The cache device 20 is connected to the cache memory 18 or may be part of the cache memory 18. The proxy file generator 16 and/or the device for caching 10 is connected to the mass storage medium 14 via a first interface 22 so as to read in the original file 12 or a plurality of original files of a set of original files and to cache it or them in the cache memory 18 as a proxy file 24. In addition, the device 10 comprises a second interface 26 by means of which the proxy file 24 or the plurality of proxy files of a set of proxy files may be output from the memory 18 to a decoder 28 or processor 28 comprising, e.g., a CPU (central processing unit) or GPU (graphics processing unit).

In the following, the functionality of the device 10 for caching one or more scalable original files 12 will be explained in detail along with the functionality of the cache device 20. A typical field of application of scalable files (cf. scalable original file 12 or scalable proxy file 24) comprises storing video sequences or audio titles in so-called media files having time dimensions. One has to distinguish between two types: on the one hand, a media file having a time component may be stored in an individual original file 12 including all of the information packets for successive frames. Typical representatives of this type are H.264 files. Another form of storing real-time media formats is employed with JPEG 2000, for example. Here, each frame is stored in an original file 12 of its own, so that the time component results from the fact that individual original files for successive frames belonging to a set of original files are represented one after the other. Irrespective of whether a multitude of frames are stored in the original file 12 and/or the proxy file 24 or in the set of original files and/or a set of proxy files, the files of both types of media files which have been described comprise comparable structures enabling scalability.

The structure of such a scalable file typically is defined by a header, a first information packet for a basic information level as well as by further information packets for a non-basic information level. In principle, the header and the first information packet of the basic information level are sufficient for reproducing and/or decoding such a scalable file. However, the decoder 28 typically awaits transferal of all of the information packets, announced by the header, of all of the information levels in the structure predefined by the original file 12, even if this were not absolutely necessary for decoding purposes. In other words, this means that for fault-free decoding, all of the information packets of all of the information levels are to be transmitted from the original file 12 to the decoder 28, or that at least the essential information packets are to be transferred to the decoder 28 as a proxy file 24 in such a manner that said proxy file 24 equals the original file 12 with regard to its structure.

To ensure this, the proxy file 24, which is equal in structure to the original file 12, is stored, e.g. as an empty file, in the cache memory 18 by the proxy file generator 16, said empty file in this form being executable in a compatible manner by any suitable decoder 28, irrespective of the error routine of the decoder 28. At least the header of the original file 12 and advantageously also the first information packet, read out from the original file 12, of the basic information level is inserted in the empty proxy file 24. Insertion takes place at the position determined by the structure, the missing information packets of the non-basic information level being replaced with empty information packets of equal size and arrangement. By means of this approach, the structure of the original file 12 is replicated; however, the information content in the cached proxy file 24 is reduced as compared to the original file 12.

The device 10 may be integrated into the file system and/or the operating system such that the decoder 28 or the application (decoding software) called up on the processor 28 directly accesses—in the event of an access operation to the original file 12, which may be part of the set of original files—the proxy file 24, which by analogy may be part of the set of proxy files. The above-mentioned time dimension of media files limits the time available during loading, since media files may be reproduced at a predefined frame rate or sampling rate so as to avoid stutters (in video reproduction) or dropouts (in audio reproduction). Consequently, the respective frame or sample may be transmitted within the predefined time window. If the transmission rate from the mass storage medium 14 to the decoder 28 is not sufficient, the device 10 described here offers the possibility of selectively discarding information packets of the non-basic information levels and thus reducing the data rate. As a result, during access the decoder 28 obtains only a specific portion of the requested data, e.g. the header and the first information packet; however, it obtains same within the time period that may be used, and it may thus reproduce the (scalable) media file and/or video or audio file in real time by exploiting the scaling at the file system level. In other words, a file system (combination of data carrier, driver and file system) which exploits the scalability of files enables compensating for bottlenecks in real-time reproduction and/or transferring a file which is operational to an unlimited extent, namely the proxy file 24, to the decoder 28 even if the data throughput between the mass storage medium 14 and the interface 22 is too low for the amount of data to be transmitted and the available time. Even though the method presented does not provide the original file 24 having the full resolution or the maximum signal-to-noise ratio, this is not necessary in many application scenarios, e.g. in the preview of a movie during post-production. It is much more important to ensure that the media file need not be additionally copied in its entirety onto a fast storage system in a time-consuming manner for a short preview.

In the event of a renewed request to the file system, for example, information packets for non-basic information levels may be reloaded from the original file 12 or the set of original files and be inserted into the proxy file 24 or the set of proxy files. In this manner, the basic information may have added to it extended information with regard to extended resolution, with regard to extended quality or with regard to an extended component, such as depth information or a 3D component. This enables high-quality representation in repeated reproduction of the media file. Such reloading advantageously takes place when the proxy file 24 or the several proxy files of the set of proxy files are repeatedly called up by the decoder 28, so that the extended information packets for a frame within the time window in which the previous frame (or the previous proxy file of the set of proxy files) is output to the decoder 28, are supplemented to the information packets already stored, i.e. before the respective frame (or the respective proxy file) is made available to the decoder 28. This reloading typically is performed in an iterative manner for such time until all of the information packets of the one or more original files 12 have been transmitted into the one or more proxy files 24. Said iterative approach offers the advantage that when a media file is first called up, fast reproduction and/or preview may be effected with reduced quality, and that in the event of further calls, high-quality output is effected as of a predetermined frame (once additional non-basic information levels have been successfully reloaded). The number of iterations depends on the frame rate, on the one hand, and on the readout speed and the file size of the original file 12 or of the set of original files, on the other hand. Said iterative reloading described above alternatively is effected in the background, i.e. when the mass storage medium is not being accessed and/or when the first provision of the one or more proxy files 24 is finished. Storing the proxy file 24 in the cache memory 18 also serves the purpose that, in the event of repeated requests, they are completely and directly made available to the decoder 28 without requiring access to the mass storage medium 14.

Should the cache memory 18 be full or should there be less storage space available than may be used for storing a further file, the cache memory 18 may free up (unblock, or mark as deletable) storage space in accordance with a displacement strategy on the part of the cache device 20.

All of said caching strategies aim at deleting those files from the memory which will most likely not be required again in the short term. With the displacement strategy, one exploits the scale-down capability of the stored proxy files 24 or, generally, of several stored scalable files. To this end, the cache device 20 analyzes the content of the cache memory 18 and selectively frees up storage locations of the proxy file 24 which have information packets of non-basic information levels stored therein. Said freeing-up of the storage locations is effected in accordance with the displacement strategy selected so that, for example, any empty or not completely stored information packets are the first to be discarded and/or to be marked as freed up, or that any most detailed extension information levels are the first to be freed up. In accordance with a further displacement strategy, freeing-up of storage space may be effected such that, for all of the frames, the quality is first of all reduced to a predefined fraction, e.g. 50%, of the original quality of the original file 12 or of the set of original files, and, subsequently, the resolution is reduced down to a predefined fraction, e.g. 50%, of the original resolution, or vice versa. As an alternative, it is also possible to reduce the resolution and the quality at the same time. A further alternative would be to reduce a further component, e.g. only for a region, instead of or in addition to the quality or resolution. Should there be, additionally, a requirement of further free storage space, the freeing-up may be effected in accordance with modified displacement strategies for scalable files or in accordance with conventional displacement strategies, such as in accordance with the FIFO strategy, wherein that file which was the first to be read in is displaced.

During freeing-up of storage space, the cache device 20 logs which information packets of the proxy files 24 have been discarded so as to replace, during repeated output of the proxy file 24 or of the set of proxy files, the discarded information packets with empty information packets and/or with information packets newly loaded from the original file 12 or the set of original files. Thus, again, each proxy file 24 is output by the device 10 such that the proxy file 24 is provided in the corresponding structure of the original file 12. Thus, there is an effect of compressing the proxy file 24 stored in the cache memory 18 without impairing the overall functionality. In the event that such information packets which contain extension information of a non-basic information level are discarded, the information content of the proxy file will be reduced, e.g. in that the resolution is reduced. In the event that only empty or incompletely stored information packets are discarded, the information content will remain constant, since only such packets which have been completely read in will be transferred to the caller.

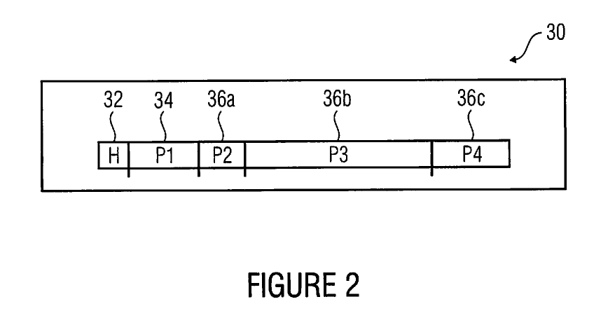

With reference to FIG. 2, the fundamental structure of a scalable file, such as of an individual JPEG 2000 file of a set of files, of an H.264 SVC file or of an MPEG4 SLC file, will be explained in detail. Scalability is based, e.g., on increments and/or on incremental image resolution or incremental quality. FIG. 2 shows a data stream 30 of, e.g., a scalable JPEG 2000 file for a first frame, said data stream comprising a header 32, an information packet 34 for a basic information level as well as three information packets 36a, 36b, and 36c for non-basic information levels. The information packets 34, 36a, 36b, and 36c are arranged in a specific order which, together with the sizes of the respective information packets 34, 36a, 36b, and 36c, defines the structure, the individual information packets 34, 36a, 36b, and 36c not necessarily having to have the same lengths. This first structure of the original file 30 is stored as structural information in the header 32. It shall be noted that the individual information packets 34, 36a, 36b, and 36c optionally each may have a header of their own which contains, e.g., structural information about the respective information packets 34, 36a, 36b, and 36c.

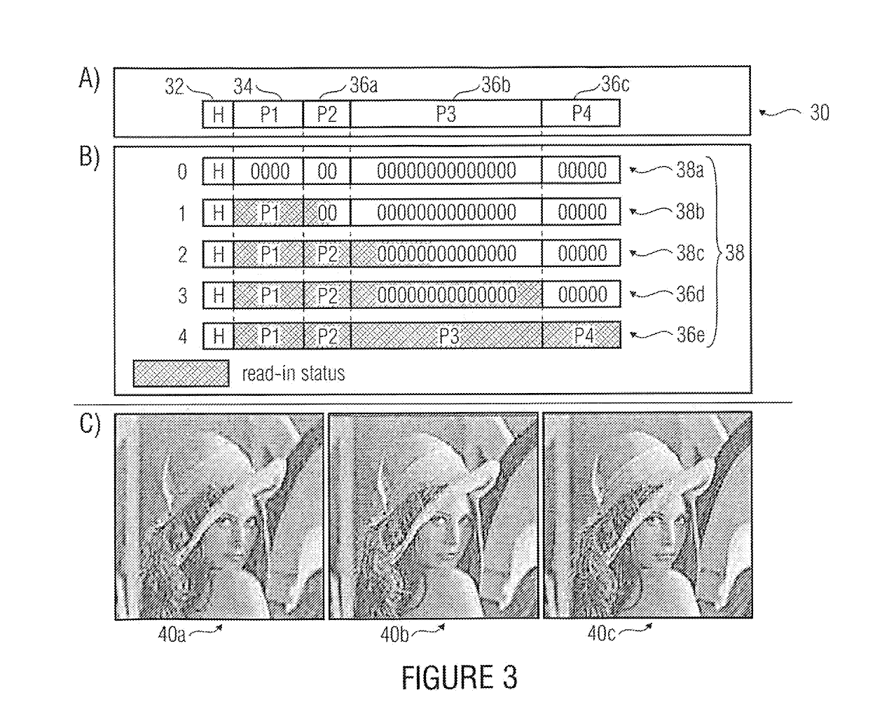

The information packets 36a, 36b, and 36c of the non-basic information levels, which are also referred to as extension information levels, extend the information of the basic information level stored in the information packet 34, and contain, e.g., information serving to increase the resolution or to improve the quality and/or signal-to-noise ratio of the image file stored in this frame (cf. increments). From that point of view, the information packets 36a, 36b, and 36c are the so-called detail packets which are not absolutely required for reproducing the respective file. However, simply discarding said information packets 36a, 36b, and 36c at the file system level, e.g. when ascertaining missing data throughput rates of the data carrier (I/O performance) would change the first structure of the original file 30 to be reproduced and/or of the data stream 30 such that an error in the decoder or in the decoding software might be caused. The background of this is that a decoding software or a decoder assumes, on the basis of reading out the header 32 and the structural information stored therein, that an image file having a specific number of information packets, file size and resolution is provided. By simply discarding the information packets 36a, 36b, and 36c, however, the file size and the structure, i.e. the position of the individual information packets within the data stream, would change, so that a decoding software or a decoder would not be able to respond to such a spontaneous change. To avoid such errors, the discarded information packets may be replaced with empty information packets which restore the structure to be expected, as is explained with reference to FIG. 1. The precise approach during incomplete reading in of the data stream 30 or during supplementing of the data stream 30 by empty information packets will be explained in more detail with reference to FIG. 3.

FIG. 3a shows the data stream 30 of an individual image (frame) representing the original file, whereas FIG. 3b illustrates reading of the information packets into the proxy file 38 from the original file 30. The differences in quality, depending on the readout status (readout progress) of the proxy file 38 are illustrated in FIG. 3c. As was explained above, the original file 30 represented here comprises the first structure, which is defined by the sequence and sizes of the individual information packets 34, 36a, 36b, and 36c. In the first step, i.e. in initialization, an empty proxy file 38a, which includes the header 32 as well as empty information packets instead of the information packets 34, 36a, 36b, and 36c, is generated by the proxy file generator on the basis of the structural information of the header 32 which has been read in. The header 32 of the proxy file 38a corresponds to the header 32 of the original file 30.

The empty information packets are generated in such a manner that they form a second structure of the proxy file 38a, which corresponds to the first structure of the original file 30. This is why the individual empty information packets are equal in size to the information packets of the original file 30 and are arranged at a position predefined by the second (or first) structure. Said empty information packets may be filled with zeros, for example, or may have a different regular bit sequence from which no extended information results. The storage space is reserved for a predefined information packet by means of a zero packet. In other words, this means that the meta data of the proxy file 38a and of the original file 30 are identical, the information packets 34, 36a, 36b, and 36c being substituted for the time being. When reproducing said proxy file 38a, a JPEG 2000 decoder would output a gray image since no information packets, or only so-called zero packets, have been inserted into the proxy file 38a as yet.

Reading in and insertion of the information packets 34, 36a, 36b, and 36c, which are substituted for the time being, is performed in the next step. In the proxy file 38b, the first information packet 34, which contains information of the basic information level, is read in from the original file 30 and inserted after the header 32. As may be seen from the gray bar, parts of the second information packet 36a have also been read in; however, they cannot be used since the second information packet 36a have not been completely read in and/or copied into the proxy file 38b. In other words, this means that the information packets 32, 34, 36a, 36b, and 36c and/or the data stream of the information packets 32, 34, 36a, 36b, and 36c are cached in the cache memory 18 without taking into account the limits of the individual information packets 32, 34, 36a, 36b, and 36c. For outputting the proxy file 38b, the information packet 36a which has been partly, or incompletely, read in as well as the information packets 36b and 36c, which have not been read in, are replaced with empty information packets (zero packets); all of the information packets 34 which have been completely read in are returned to the decoder. For the decoder this means that from a specific point onwards, it will obtain empty information packets only, which has the same effect as obtaining no more packets. Even though the existence of the empty information packets adds no further detailed information to the image so far decoded, it will enable adherence to the data structure of same, including the internal architecture. The image 40a is the result of the proxy file 38b being decoded and is based exclusively on information of the basic information level (cf. information packet 34). Consequently, the image 40a comprises marked block artifacts which may be attributed to the missing information packets 36a, 36b, and 36c of the extension information level.

In parallel with reading-in of the information packets 34 and 36a, the information packets which have not yet or not been completely read in are logged by means of a so-called read-in status, which indicates information packets 36a, 36b, and 36c of the non-basic information level which are yet to be loaded. On the basis of this read-in status, the device may continue reading in, for repeated read-in, at that location where the previous read-in operation was aborted.

When read-in is continued, the second information packet 36a of the non-basic information level is completed, and parts of the third information packet 36b are read in, which results in the proxy file 38c. The second information packet 36a is inserted into the proxy file 38c at that location, predefined by the structure (after the first information packet 34) which was reserved by an empty information packet in the proxy file 38b. In the next read-in operation, the third information packet 36b continues to be completed, so that the proxy file 38d is produced. Here, the third information packet 36b is not completely read in (cf. gray bar), so that the latter in turn is replaced with an empty information packet. The image 40b results from the representation of the proxy file 38c and the proxy file 38d and illustrates the improved resolution as compared to the image 40a, which is the result of the information of the information packet 36a which was taken into account, i.e. information of an extension information level.

The proxy file 38e, which has been completed during further read-in, contains, in addition to the information packet 34 of the basic information level, all of the information packets 36a, 36b, and 36c of the non-basic information level. The image 40c is the result of the decoding of the proxy file 38e. Since all of the information of the information packets 36a, 36b, and 36c of the non-basic information levels are processed in the image 40c, the latter consequently has an increased resolution and/or quality as compared to the images 40a or 40b, said resolution and/or quality corresponding to the resolution and/or quality stored in the original file 30. In summary, it may be stated that, as expected, the quality of the images 40a to 40c will be the better, the fewer data had to be replaced in the proxy file by the device.

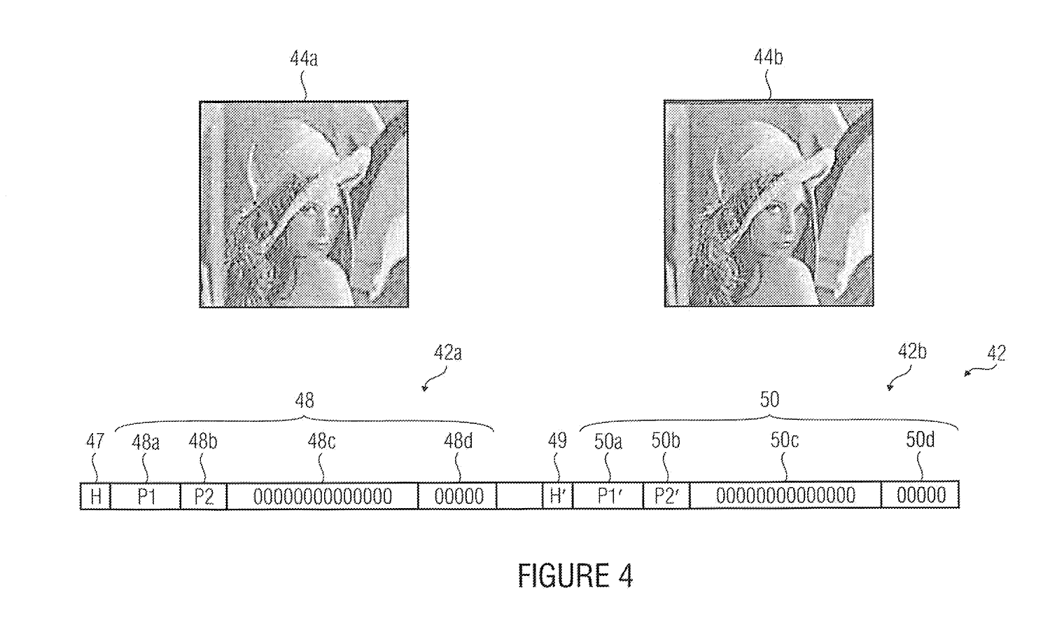

FIG. 4 shows a set of proxy files 42 having an image sequence stored therein. The image sequence includes two successive frames 44a and 44b, each frame being stored in a proxy file 42a and 42b, respectively. The set of proxy files 42 comprises a first proxy file 42a having a first header 47 as well as information packets 48 for the first frame 44a, and a second proxy file 42b having a second header 49 as well as information packets 50 for the second frame 44b. Each header 47 and 49, respectively, for the respective proxy files 42a and 42b provides information about the number of information packets which follow within the current frame and about the size of each individual information packet. In the set of original files, the first original file comprises, for the first frame 44a, a first information packet 48a of the basic information level as well as three further information packets 48b, 48c, and 48d of the non-basic information level. The second original file of the set of original files for the second frame 44b also comprises four information packets 50, of which the first information packet 50a belongs to the basic information level and the three further information packets 50b, 50c, and 50d belong to the non-basic information level.

The two successive frames 44a and 44b are reproduced e.g. at a frame rate of 24 images (frames) per second (fps), so that the time between read-in of the first proxy file 42a with the information packets 48 of the first frame 44a and of the second proxy file 42b with the information packets 50 of the second frame 44b is limited. The mass storage medium is too slow to provide all of the information packets 48 and 50, respectively, for the two successive images 44a and 44b within a specific amount of time, so that the specific number of images having the predetermined frame rate cannot be output at the full data rate. This is why in the first proxy file 42a, the incompletely or not loaded information packets, e.g. 48c and 48d, are replaced with empty information packets, so that from a specific point in time, the header 49 and the information packets 50 may be loaded for the subsequent frame 44. For the example shown, this means that for reproducing the set of proxy files 42, first of all the header 47 and, subsequently, the first information packet 48a of the basic information level as well as the second information packet 48b of the non-basic information level may be read out and cached for the first frame 44a. In the transferal of the first proxy file 42a to the decoder, the further information packets 48c and 48d are replaced with empty information packets prior to provision. The information packet which is read out next is the header 49 of the second proxy file 42b. In this second proxy file 42b, too, the first two information packets 50a and 50b are read out, and the last two information packets 50c and 50d are replaced with empty information packets.

The timing as to when the device stops loading the information packets 48 of the first proxy file 42a and starts loading the information packets 50 of the second proxy file 42b may be determined by two different mechanisms. For example, triggering may be performed by means of a signal on the part of the decoder or a different receiver of the set of proxy files 42 which instructs the device to end loading of the information packets 48 and to output the proxy file 42a (after insertion of the empty information packets 48c and 48d) and to start loading the information packets 50. A further possibility is for the proxy file generator to autonomously determine the change between the frames 44a and 44b on the basis of the frame rate, which basically predefines the time period between two successive frames 44a and 44b, and determines on the basis of the readout speed of the information packets from the mass storage medium, and adapts readout and provision of the information packets 48 and 50 accordingly. In this context, the device may optionally include a readout speed determiner.

Replacing the non-loaded information packets 48c, 48d, 50c, and 50d with empty information packets (zero packets) in the cache memory corresponds to dedicating storage space to the respective information packets 48c, 48d, 50c, and 50d. Alternatively, it is also possible for the empty information packets to be inserted or copied into the data stream and output when being provided. In this context, the empty information packets 48c, 48d, 50c, and 50d are generated on the basis of structural information and are provided, when being output, such that the second structure of the proxy files 42a and 42b corresponds to the first structure of the original files. This offers the advantage that there is no dedication of the storage space by empty information packets and, thus, no storage space is wasted. If at a later point in time the information packets 48c, 48d, 50c, and 50d are read in and cached, they will typically be stored in storage locations not directly associated with the storage locations of the information packets 48a, 48b, 50a, and 50b, so that fragmentation will occur. In such cases, information about the relationship between the fragmented information packets 48 and 50, respectively, are stored in a separate database, so that combining the information packets 48 and 50, respectively—which belong together—will be possible during output.

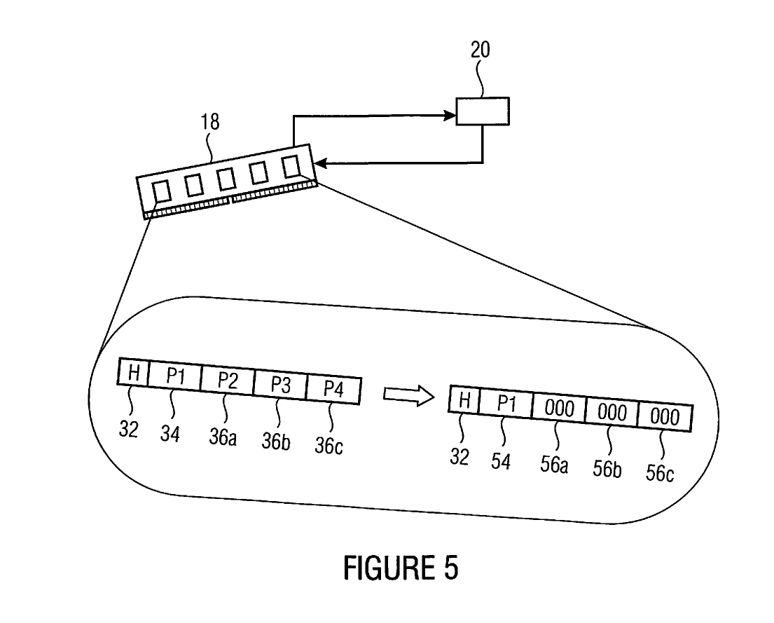

With reference to FIG. 1 to FIG. 4, a system is described for processing a scalable file, said system comprising a device for caching the scalable file and a cache device. With reference to FIG. 5, a cache device 20, which manages the cache 18 in accordance with a displacement strategy, will be described in detail.

FIG. 5 shows a cache device 20 which is connected to or part of the cache memory 18. As is also mentioned with reference to FIG. 1, the cache device 20 analyzes the information packets (data) or proxy files which are stored in the cache memory 18 and which possibly are also part of a set of proxy files and may be combined in an MXF or AVI container. According to requirements, the cache device 20 then releases those information packets which are identified as information packets of non-basic information levels and which are to be released in accordance with the respective freeing-up strategy. To this end, different strategies may be applied, which will be explained in more detail in the following.

A first freeing-up strategy is based on the fact that the cache device 20 marks as freed up those memory locations which are occupied or reserved by empty information packets and/or incompletely read-in information packets. Said discarded information packets are replaced, during output, with empty information packets and/or zero packets, so that the structure of the stored proxy file is preserved. The positions—in the data stream to be output—into which empty information packets are to be inserted might be determined, for example, by means of the header in which the structural information is stored or by means of a freeing-up status which is logged in parallel to the freeing-up. In accordance with a further displacement strategy it is possible to discard any information packets that cannot be used for representation since, e.g., information packets are indeed present in a complete manner, but cannot be sent to the calling application for representation for reasons of data stream validity (code streaming validity) since further information packets (data packets) of the data stream (code stream), such as a further information packet 34 and/or 54 of the basic information level, for example, are missing.

In accordance with a further freeing-up strategy, such information packets of the non-basic information level, e.g. the information packets 36a, 36b and 36c, may be released which, however, have been completely read in unlike the first freeing-up strategy. Here, the information packet belonging to the most detailed extension information level and/or containing the information having the highest level of detail, i.e. the information packet 36c, is advantageously released before the information packets 36b or 36a are released in the order of their scale-down capability (their stored level of detail). By analogy with the first freeing-up strategy, the cache device 20 may log the released or discarded information packet in the freeing-up status and may then replace same with an empty information packet 56c (or 56b and 56a) prior to outputting the proxy file or the set of proxy files.

In accordance with further embodiments, the information packets 36a, 36b and 36c may be released. According to requirements, and be replaced—during output—with empty information packets 56a, 56b and 56c in such a manner that first of all the resulting quality, i.e. the signal-to-noise ratio, of the media file is reduced down to a predefined fraction, such as 50% or 25%, for example, of the original quality before the extended resolution is subsequently reduced down to a predefined fraction, such as 50% or 25%, for example, of the original resolution. Alternatively, it would also be possible for the information packets 36a, 36b and 36c to be released in such a manner that the extended quality and the extended resolution are simultaneously reduced down to a minimum value, e.g. of 25% or 50%, of the original quality and the original resolution of the original file or set of original files. Such a displacement strategy is not restricted to the percentage values depicted. For example, a method is feasible wherein, in a first step, the quality of the proxy files is reduced to 75%, and in a second step, the resolution is reduced to 75%. In a third step, the quality may then be reduced to 50%, whereas in a fourth step, again, the resolution would be reduced to 50%. In addition, instead of the quality or resolution component, it is alternatively also possible to reduce the information content for other components so as to free up storage space.

In accordance with further embodiments, it would also be possible to take into account the predicted readout speed in selecting the information packets to be discarded. Here, the cache device 20 may then—as and when the cache memory 18 fills up—free up precisely that storage space which upon a renewed access operation under real-time conditions may be directly reloaded from the mass storage and/or another data carrier even if, during freeing-up of storage space, information packets of complete frames are released. In this manner, the complete proxy file and/or a complete file of a set of proxy files with all of the information levels would invariably be provided to a decoder, since the one part of the proxy file is reserved in the cache memory 18, and the other part is directly reloaded from the original file from the mass storage medium. Combining the two parts from the proxy file or from the original file into a complete data stream may be effected by the cache device 20 or the device 10 for caching, which is integrated, for example, into the target machine as a virtual file system. It would be an advantage here for this method to also be applicable for non-scalable files.

A further displacement strategy of the cache device 20 is to mark as released those information packets 36a, 36b and 36c of the non-basic information level which take up the most storage space or which come closest to the storage space that may be used in terms of size of the storage space, and/or which correspond to the storage space that may be used.

In summary it is to be stated that freeing-up of storage space may be effected in accordance with any of the above-mentioned displacement strategies or in accordance with a combination of the above-mentioned displacement strategies. From that point of view, in accordance with further embodiments, freeing-up of storage space may be effected in an iterative manner, so that when the cache memory 18 fills up for the first time, the storage locations are freed up in accordance with the first displacement strategy, and when the cache memory 18 fills up again, a decision is made, in accordance with a further displacement strategy, as to which information packets are discarded and/or marked as released.

However, it shall also be noted that the displacement strategies explained above cannot be employed indefinitely since, e.g., the resolution and the quality of a media file can only be reduced down to the basic information level at the most. For additional freeing-up of the storage space that may be useful, it would be possible, in accordance with further embodiments, for the cache device 20 to employ classic replacement strategies (FIFO, LFU, LRU), by means of which the remainder of the stored (media) file is removed.

It shall be noted at this point that the displacement strategies are not restricted to the displacement strategies mentioned, but that further displacement strategies are possible which comprise a modification of the above-mentioned displacement strategies or are constituted by a combination of the above-mentioned displacement strategies with conventional displacement strategies. However, all of the displacement strategies employed by the cache device have in common that freeing-up of storage space is effected such that a stored file or set of files need not necessarily be completely discarded, but that individual parts (information packets) of a file, which possibly is part of a set of files, are released while utilizing their scalability.

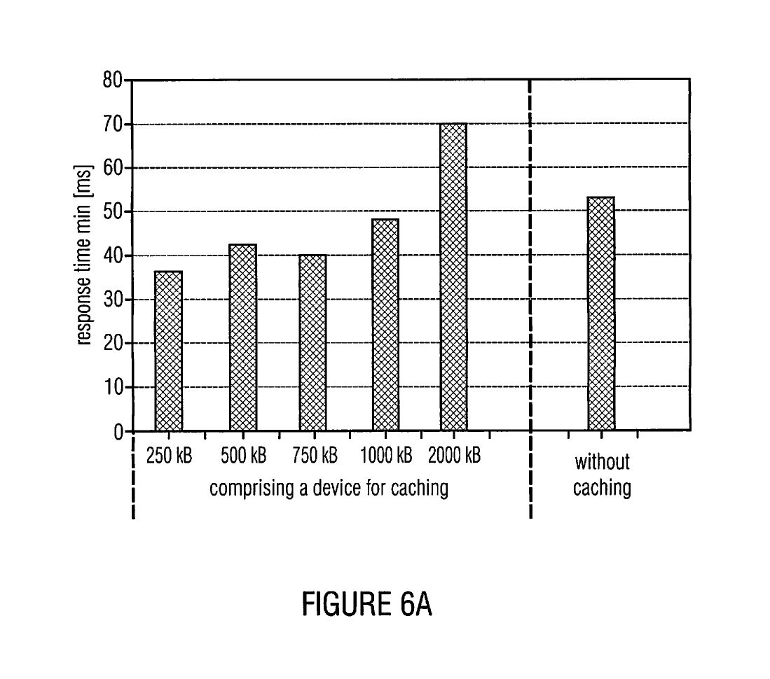

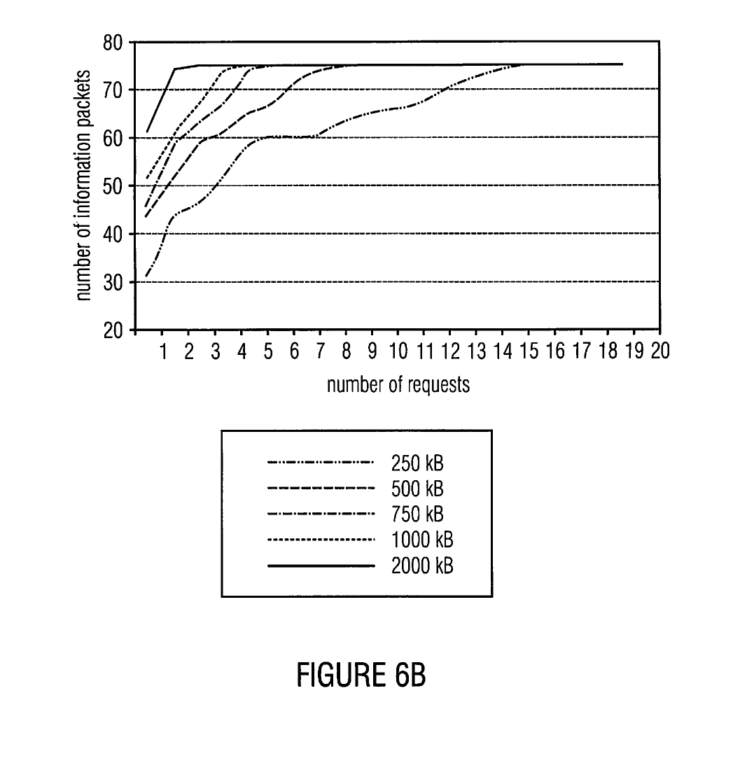

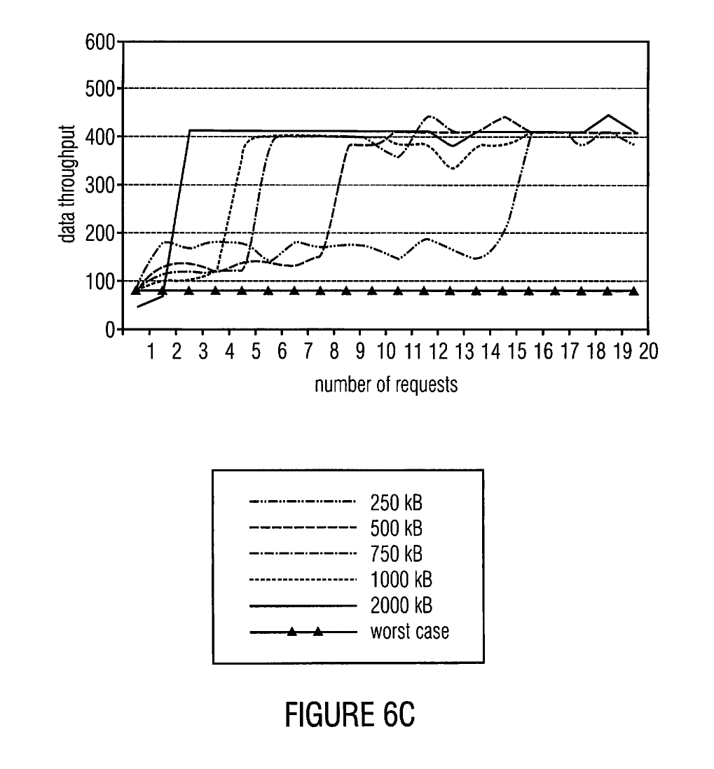

The improvement in real-time reproduction of JPEG 2000 files on a standard PC by the device described in FIG. 1, which is implemented as a virtual file system here, is explained by means of the diagrams shown in FIG. 6. As will be described in the following, the effective applicability of the cache device 20 described in FIG. 5 may also be shown by means of this series of measurements. A JPEG 2000 file having a sequence of images is used as a test file, each image comprising an average file size of 3.5 MB and a resolution of 2 k. There are four resolution stages and five quality stages available for each image, so that the file is scalable by means of said stages. Each data stream contains 75 information packets. When assuming that the file system provides 24 fps to enable real-time reproduction, the response time will amount to 42 ms for each frame, which corresponds to a data throughput of 84 MB/s.

FIG. 6a shows the measurement results in a hard disk speed measurement or measurement of the minimum response time of the hard disk. Here, the minimum response times when using a device and/or file system described above for caching is compared to the minimum response time without caching. The minimum response times were determined on the basis of a standard PC having a convention hard disk. It is noted that in the utilization of the device for caching, the minimum response times are classified for various block sizes. In this context, one assumes a request of an image from a decoder, which request is made to the virtual file system, the virtual file system forwarding the request to the conventional hard disk. Subsequently, the original file is transmitted from the hard disk into the cache memory in dependence on the block sizes of 250 KB, 500 KB, 750 KB, 1000 KB or 2000 KB, and the incomplete or missing parts are replaced with empty information packets, as was described above.

As may be seen from the diagram, the minimum response time for a conventional hard disk without any device for caching amounts to 52 ms, which corresponds to a maximum data throughput of 66 MB/s. This means that real-time reproduction at 24 frames per second (24 fps) is not possible here. With the aid of the device for caching, real-time reproduction may be enabled at a block size of 250 KB and 750 KB, since here, the average response times of 36 ms and 41 ms, respectively, are smaller than the 42 ms that may be used.

The larger the file size of the original file, the higher the efficiency of the device will be, since a conventional hard disk can only provide a fixed data rate in a continuous manner, and since, consequently, the number of frames per second would decrease in the event of a larger file size, whereas the performance would not deteriorate in the event of using the device for caching. This means that the performance remains constant, since the defined block sizes would be read out from the original file, and the missing information packets and/or empty information packets would be replaced. In the event of a reduction of the block size, e.g. 250 KB, the response time would be further reduced, which enables also employing slower mass storages, e.g. USB sticks or optical drives, or network-tied streaming applications for such (real-time) applications. Since the data throughput performance is dependent on the block size, further improvement of the data throughput may be achieved by using a dynamic block size. By means of said test files, the displacement strategy from the cache memory for scalable media data has also been investigated. It has been found that freeing up storage locations which contain information packets for very detailed non-basic information levels has no influence on the preview function of the media file since in the second request for the media file typically all of the information packets for all of the information levels may be loaded into the cache memory again. This is shown by means of FIG. 6b.

FIG. 6b shows the number of information packets of the test file (data packets) in the cache memory, plotted over the number of requests made to the virtual file system and/or the device for caching. As may be seen, various diagrams are depicted for the different block sizes. It may be seen that the larger the block size, the fewer requests may be used for completely storing the test file into the cache memory. One may see that when utilizing a block size of 700 KB, more than 50% of all of the 75 information packets of the scalable file will be stored in the cache memory following the first access to said scalable file, which is sufficient for preview purposes. This is true in particular when small display sizes are used.

FIG. 6c shows the resulting data rate between the requester (caller) of the information packets, e.g. decoder and the device for caching and/or the virtual file system in dependence on the number of requests. Here, the data rate is again represented for different block sizes. As may be seen, the data rate increases in an irregular manner until all of the information packets of the proxy file or of the set of proxy files have been completely cached in the cache memory. The performance increases up to 410 MB/s. A higher performance may be achieved by directly integrating the device into a non-virtual file system. As a result of said transfers, the overall system performance will be reduced. Relocation of the file system to the system kernel (implementation of the file system in the system kernel), for example by means of a port, might significantly improve performance.

Even if aspects of the scalable file were explained above in connection with a JPEG 2000 file, it shall be noted that said device is applicable for any scalable files, such as H.264 SVC files or MPEG4 SLC files, for example.

With reference to FIG. 1, it shall be noted that in accordance with further embodiments, the device 10 and/or the proxy file generator 16 not only output the proxy files 24 to the decoder 28 via the interface 26, but also obtain control signals, e.g. start-stop of reproduction of an image sequence, from same via the interface 26.

With reference to FIG. 1 it shall further be noted that the device for caching and, thus, also the cache device may either be an integral part of a main memory, of a processor, of a decoder, of a mass storage medium, or of a controller of the mass storage medium, so that the device is not necessarily restricted to being employed at a specific location in the processing chain between the mass storage medium and the decoder.

It shall be noted with reference to FIG. 3 that the information packets 36a, 36b, and 36c of the extension information level may also comprise other extension information, e.g. for further details of the resolution, of the quality or another component in a restricted image area, and, consequently, cannot be restricted to extension information with regard to extended overall image resolution or overall image quality. It shall further be noted that a scalable file need not necessarily be a media file. For example, a text file may also comprise different levels, e.g. for organization, text body and graphics, which enables scalability thereof.

With reference to FIG. 4 it shall be noted that the set of proxy files 42 may be stored in a specific folder or container, such as in an MXF or AVI container, for example, which may also comprise information about the number of individual images and/or files as well as about the predefined frame rate. It shall also be noted that an image sequence wherein the individual frames are stored in a single file are cached in an analogous manner. Here, the set of proxy files 42 represents the actual proxy file wherein the first frame 44a in the information packets 48 is stored at different information levels, and the second frame 44b in the information packets 50 is also stored at different information levels. From this point of view, such a proxy file 42 combines, by analogy with the above-mentioned container of the set of proxy files 42, data (bytes) which belong together in terms of content. It shall further be noted that the proxy file 42 may comprise, e.g., only a first header, namely the header 47, or one header 47 and 49, respectively, for each frame 44a and 44b, the first header 47 typically having the structural information stored therein.

The above-described device for caching may be used not only as a file system and/or for data storage, but may also be employed for image processing, e.g. in transcoding, for image archiving or, generally, for file management of scalable image files. Further fields of application are so-called content distribution and content streaming.

Even if embodiments of the present invention are described in connection with a cache device for caching, it shall be noted at this point that the aspects described also relate to a method of managing a cache memory of a cache device. Consequently, the aspects that have been described in connection with a device also represent a description of the corresponding method, so that a block or a component of a device may also be understood as a corresponding method step or as a feature of a method step. By analogy therewith, aspects which have been described in connection with or as a method step shall also represent a description of a corresponding block or detail or feature of a corresponding device. Some or all of the method steps may be performed by a hardware apparatus (or while using a hardware apparatus), such as a microprocessor, a programmable computer or an electronic circuit, for example. In some embodiments, some or several of the most important method steps may be performed by such an apparatus.

An advantageous embodiment of the above-described device will be discussed below in detail while using different words. The invention report shows methods of incrementally improving image data in the event of several call-ups while using an adapted file-caching strategy for scalable media data, such as JPEG 2000 or H.264 SVC. In addition, displacement and/or replacement strategies for caching methods, which have also been developed for the properties of scalable (image) formats, will be introduced. Common caching methods discard entire files—or mark all of the blocks which belong to a cached file as free—so as to thereby free up storage space for new data. However, when using scalable media data, even the release of parts of a file—or of the blocks within the cache which cache parts of the file—may result in that, on the one hand, sufficient storage space becomes available for new data and that, on the other hand, there are still usable data of a file within the cache, e.g. images of a lower resolution and/or having a lower quality. As a result, it will not be necessary, in the event of a new request, to read from the supposedly slower mass storage. The methods introduced here may be combined and enable an increase in performance when storing, managing and providing scalable media data.

Digital movie distribution and archiving entails image compression in order to reduce the storage requirement. The Digital Cinema Initiative [1] defines utilization of JPEG 2000[2] for distributing digital movies. Image sequences may be compressed at a data rate of up to 250 MBits/s. The same tendency may be observed in the field of digital archiving. Here, too, JPEG 2000 seems to be the codec desired since it offers both lossy and lossless compression. The data rates here are typically higher than in digital cinema. The International Organization for Standardization (ISO) has defined, specifically for the field of digital archiving, new JPEG 2000 profiles [3] having data rates of up to 500 MBits/s or even lossless compression.

For years it was impossible to decode such a JPEG 2000-compressed image sequence on a standard PC without any specific accelerator cards since the available computing resources of the processors were not sufficient. Presently, current processor families—as well as algorithms executed specifically on graphics cards [4]—provide the computing power that may be used so as to ensure real-time reproduction of the movies.

Unfortunately, these results resulted in a new bottleneck in the processing chain: current consumer hard disks are not able to provide the data within the appropriate amount of time so as to be able to reproduce a movie in real time (typically with 24 images per second). Especially external hard disks—connected via USB, for example—lack the resources that may be used. This results in that reproduction software may keep skipping frames during reproduction, even if the decoding performance that may be used were actually available.

Fortunately, JPEG 2000—besides other media formats such as H.264 SVC [5] or MPEG4 SLC [6]—is designed such that it allows scalability in various dimensions, e.g. quality or resolution. In this manner it is possible to discard specific packets of the data stream of the compressed file in the event of too low a computing performance of the target machine; as a result, the images will be smaller (scaling of the resolution) or lower in quality (scaling of the quality). Thus, scaling allows compensating for missing (decoding) resources. This is already made use of today at the application level.

Unfortunately, current caching methods so far have not utilized the functionality of scalability. This results in that in managing scalable media data, a so-called cache miss occurs with unnecessary frequency. In this case, a file which has already been read in—or a block of data which belongs to a file—can no longer be loaded from the cache since the latter had to free up the space for new data. This results in that the corresponding data may again be read from the typically slower memory (e.g. the hard disk). Complete replacement of all the data of a file within the cache for freeing up storage space also represents a useful approach for non-scalable file formats since a smaller portion of the data is of no use to the caller. When managing scalable files, it may be useful, however, to remove only a portion of a file—or the corresponding blocks within the cache memory—from the cache memory so as to thereby free up storage space for further data within the cache.

In addition, reproducing high-quality image material for digital archiving is an application which is above the performance limit of current consumer hard disks. The result is that hard disks cannot make available the requested data within the amount of time that may be used. At this point, too, the scalability of (image) data may be exploited since it is not necessarily the entire file that may be sent to the caller. By combining the methods presented here and an adapted caching strategy for scalable media data, the requested images may be incrementally improved in terms of resolution and quality. The problem has been solved so far by the following methods:
Utilization of larger cache memories. As a result, a longer image sequence may be loaded into the cache. However, to this end the data may be requested at least twice. At the first time, the data is copied into the cache, however it cannot be made available within the amount of time that may be used. At the second request, the data is then read out from the fast cache.
Creation of proxy files. To this end, relatively small data packets, possibly in a different data format, are generated prior to viewing the material. As a result, the data volume is reduced, and real-time capability is achieved.
Re-coding at a reduced data rate. Results in a reduction in the image quality. Must be initiated beforehand. Results in two variants of the same media file which have to be managed.
Utilization of fast(er) hard disks with movable write/read heads. Current hard disks can already provide data for the field of application of digital cinema in real time even today. However, in the future one will have to expect that both image repetition rates and the data rates per second themselves—and, thus, the data throughput that may be used—will increase, so that this generation of hard disks will rapidly reach its limits. Moreover, said hard disks are costly, and utilization of faster hard disks is not always possible, particularly when they are connected via a limited I/O interface—such as USB, for example. In addition, even in this case, the data cannot be provided fast enough in the event that several data streams are requested (parallel reproducing of several videos).
Utilization of Flash memories. The same advantages and disadvantages as in the utilization of faster hard disks with movable write/read heads. The price is clearly higher in comparison (as of December 2011).
Combination of several hard disks in a so-called RAID (redundant array of independent hard disks) system. In this manner, several hard disks (depending on the RAID system, different numbers of disks may be used) are combined so as to be able to achieve higher writing/reading speeds. Particularly with fixed installations, this is a frequently used method of increasing the performance of data memories. However, it is largely unsuitable for mobile applications (keyword: USB).

### Read-in Strategy and File Caching:

The approach is to be explained by means of the compression format JPEG 2000. In principle, the methods may also be transferred to other formats. [7] provides a description of how scalable files may be filled up with so-called zero packets in order to circumvent bottlenecks in the provision of images by the storage medium while maintaining the original structure of the original file. The method presented provides as many data as may be read from the memory within a predefined period of time.

The method described may be adapted and extended by utilizing an adapted cache for scalable media data. Since it may be safely assumed that it had not been possible to completely read the image from the data carrier during a previous access operation, only part of the file was therefore provided to the calling application; incomplete or missing packets were replaced with zero packets. This smaller part is sufficient for being able to present the image in a reduced variant.

In addition, a method is feasible which continues reading, upon a renewed access operation to the same file, at that location of the original file at which the latest access operation to the storage medium ended—due to the specified timing. If the image (or the blocks of a file representing an image) has not been removed from the cache memory in the meantime, e.g. the quality of the image will improve with each new access operation since the data within the cache keep being added to and since more and more zero packets may be replaced with the correct data from the storage medium in the process. In particular, this method, too, possesses real-time capability—a property that is very important in the post-production of the above-mentioned subject areas.

The difference as compared to a conventional method consists in that conventional methods do not take scalability into account. If the method introduced in [7] were employed without the extension described here, the file would be completely within the cache as early as after the first access operation, from the point of view of an operating system since, after all, the file system has already provided a complete file. However, a normal cache has no intelligence that would report that there are still a large number of zero packets in the cached data, and would simply provide, in the event of a new request, the data from the cache to the calling application. On account of the extension, the cache would try to improve the data which has already been cached.

In addition, a method is feasible which replaces, upon the first access operation, the zero packets in the cache with the correct data from the mass storage not only in the event that a renewed request has been made to a file, but which also incrementally reloads the data during writing/reading pauses of the mass storage so as to thereby improve the quality/resolution of the cached file.

FIG. 3 shows the approach in an iterative read-in method for scalable media data. A JPEG 2000 data stream (codestream) consists of a header packet and subsequent data packets (FIG. 3a), Orig.) each of which contains image data for the various scalable dimensions (resolution, quality, component, region (or region of interest). Prior to a first access operation to the file—in accordance with the substitution method of [7]—the structure of the file is replicated in the memory of the cache, and any packets existing in the codestream are filled up with zeros (FIG. 3a) Req 0).

It is irrelevant in this context whether storage space is actually created—for packets which are still unread—and is filled with zeros as early as at the first access operation, or whether a note concerning the packet which has not yet been loaded is sufficient. The second variant already represents an optimization with regard to capacity utilization of the memory since, in this manner, storage space is not unnecessarily created for zero packets. In the event of a concrete access operation, the system may also provide zeros without them being stored in the cache.

Following the first access operation, the situation will be as in FIG. 3a) (Req1): During the predefined time period already, it was possible to read so much data that the first packet (P1) is completely within the cache. In addition, the reading speed in the example allows that the subsequent packet (P2) has already been partly read. Due to the structure of the JPEG 2000 codestream, however, only packets which have been completely read in are allowed to be provided back to the calling application since otherwise invalid representation of the image would occur after decoding. Thus, the first access operation provides a codestream in which the first packet is filled with the data of the original image, and any further packets are filled with zeros. The result can be seen in picture 1b) (left-hand image): It can be recognized that the image exhibits marked block artifacts (e.g. at the edges) and that many details are missing.

Following the first access operation to the image, however, the data is not discarded but is stored in the cache presented here. Upon a new access operation to the file, reading is continued at that point where the first access ended. By means of access operations Nos. two and three to the same file (FIG. 3a) (Req 2 and Req 3), further packets may be loaded and stored in the cache. By analogy with the first access operation, only complete packets are provided to the caller—both access operations therefore provide the same result (cf. FIG. 3b) (central image)). The following access operation (FIG. 3a) (Req 4)) completely fills up the packets P3 and P4. The calling application obtains the image in FIG. 3b) (right-hand image), which provides a very high quality.

### Displacement Methods for Scalable Files:

For any caching methods, the available memory (storage space) represents the limiting resource. For this reason there are a multitude of so-called displacement methods intended to delete precisely those files from the memory which are least likely to be required again in the short term. Without raising any claim to completeness, three known methods shall be mentioned here since they may also be combined at a later point in time with the newly presented methods:
1. FIFO (first in first out)—the file that was the first to be read in is removed.
2. LRU (least recently used)—the file not accessed for the longest period of time is removed.
3. LFU (least frequently used)—the file that has been least frequently used is removed.

All of these methods have in common that they will or will not completely remove a file (or the data blocks belonging to a file) from the cache. Partial removal is not aimed at since typically a portion of the file is of no use to the caller.

When using scalable files, however, it may be useful to remove only part of the file (or the corresponding blocks) from the cache since in this manner the image (or a movie, a song, etc.) will still be available in a reduced resolution. Therefore, upon the memory of the cache used filling up, those packets which contain data for the highest level of details will be discarded. Any other packets will remain in the cache. Because of the storage space being freed up, new entries may be inserted into the cache, and the storage bottleneck is remedied for the time being. Upon the memory filling up again, one will have to decide again which packets to discard. In this context it may be useful, e.g., to discard any packets which contain data for the highest level of resolution, etc. The approach set forth here may be combined with the methods presented in [7] in an ideal manner since said combination will ensure that the data structure is maintained and that any calling applications are not aware that the data in the cache has changed.

Depending on the structure of the files stored (how many quality levels/resolution levels, etc. are made available by an image), the extended displacement strategies cannot be employed indefinitely since, e.g., the resolution and quality cannot be reduced any further.

In this case, those classic replacement strategies (FIFO, LFU, LRU) may be employed which completely remove the remainder of the images.

In particular, this invention report claims the following replacement strategies:
Any scalable dimensions existing in the source data. Said dimensions may be different in the different scalable data formats. JPEG 2000 allows, e.g., scaling in the dimensions of resolution, quality, component and region.
Combined exploitation of scalability: a combination of the scalable dimensions included, e.g. a method which first of all reduces the quality down to a maximum of 50% of the original quality and then reduces the resolution down to a maximum of 25% of the original resolution. But also a method which allows reduction down to 75% in terms of quality, then down to 75% in terms of resolution, then again down to 50% in terms of quality, etc.
A strategy which initially exploits scalability for replacement and subsequently falls back on the classic caching strategies.
A strategy which initially makes use of combined scalability (quality down to 50%, then the resolution down to 25%, etc.) and subsequently falls back on the classic caching strategies.
A strategy which keeps discarding those packets (irrespective of their dimensions) which free up the most storage space within the cache. Here, the cache may determine whether a larger amount of storage space may be freed up by, e.g., discarding the maximum resolution level or, even better, by discarding the maximum quality level of all of the images. Finally, the data of the dimension determined are deleted for all of the images.
A strategy which invariably discards those packets (regardless of their dimensions) which free up the most storage space within the cache. For each file, that data packet which releases the most data will be discarded.
A strategy which discards any incomplete packets of the scalable data so as to thereby free up storage space for new data.
A strategy which discards any packets which cannot be utilized for representation. This may be the case, e.g., when packets are indeed completely in the cache, but for reasons of codestream validity cannot be sent to the calling application for representation because other packets are missing.
A strategy which discards, upon the memory filling up, as many data of images (or files) which are completely in the memory as may be reloaded by the data carrier under real-time conditions upon a renewed access operation. In this manner, it would invariably be the entire file that is provided: part of the data is available within the cache, the other part would be reloaded by the data carrier. In particular, this method might also be expediently used for non-scalable data formats.

Due to the utilization of caching methods while taking into account scalability, the performance of storage systems, in particular hard disks with movable write/read heads, Flash memories and memories which are connected via an interface having a highly limited data rate (e.g. USB), may be significantly improved. The methods presented enable accelerating access operations to files and providing higher quality of the data used than is possible with methods available today.

Even though the methods presented do not always provide the original files from the hard disk, in many application scenarios this is unnecessary. For example, when previewing a movie in a post-production house, it is often not important for the data to be reproduced with full resolution and quality. It is much more important that the data does not specifically have to be copied, for a short preview, onto a faster storage system in a time-consuming manner so that viewing of the data becomes possible at all. In addition—particularly in the above-mentioned fields of application—short sequences of a video sequence are viewed again and again in a loop mode. In this case, the methods introduced serve the purpose of real-time application including incremental improvement of the image quality upon each call.

The methods presented here might also be implemented at the application level. In this case, the corresponding end application rather than the file system would be the block that would be responsible for caching and corresponding replacement strategies.

In addition, one might try to place differently structured data, rather than zero packets, at that location where original data is missing.

Exchanging packets within a data stream describing a scalable (image) file in combination with a caching method optimized for scalable files so as to thereby increase the performance of storage systems also represents an embodiment.

The invention presented may be utilized in the following fields of application:
data storage
data systems
image processing, e.g. transcoding
permanent storage (archiving) of image material
data management for scalable image data
content distribution
content streaming

A signal encoded in accordance with the invention, such as an audio signal or a video signal or a transport stream signal, for example, may be stored on a digital storage medium or may be transmitted on a transmission medium such as a wireless transmission medium or a wired transmission medium, e.g. the interne.

The audio signal encoded in accordance with the invention may be stored on a digital storage medium or may be transmitted on a transmission medium such as a wireless transmission medium or a wired transmission medium, e.g. the internet.

Depending on specific implementation requirements, embodiments of the invention may be implemented in hardware or in software. Implementation may be effected while using a digital storage medium, for example a floppy disk, a DVD, a Blu-ray disk, a CD, a ROM, a PROM, an EPROM, an EEPROM or a FLASH memory, a hard disk or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the Internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### SOURCES

[1] Digital Cinema Initiatives (DCI), “Digital Cinema System Specification V1.2”, 7 Mar. 2008
[2] ISO/IEC 15444-1 “Information technology—JPEG 2000 image coding system—Part 1: Core coding system”, 2000
[3] ISO/IEC 15444-1:2004/Amd 2:2009 “Extended profiles for cinema and video production and archival applications”, 2009
[4] V. Bruns, H. Sparenberg, S. Fossel, “Video Decoder and Methods for Decoding a Sequence of Images”, Patent, unpublished
[5] H. Schwarz, D. Marpe, T. Wiegand, “Overview of the Scalable Video Coding Extension of the H.264/AVC Standard”, IEEE Transactions on Circuits and Systems for Video Technology, Vol. 17, No. 9, 2007
[6] R. Yu, R. Geiger, S. Rahardja, J. Herre, X. Lin, H. Huang, “MPEG-4 Scalable to Lossless Audio Coding”, Audio Engineering Society, San Francisco, 2004
[7] U.S. Provisional Application 61/568,716

1. A cache device for caching files in a cache memory, the cache device exhibiting a replacement strategy according to which scaling-down of one or more scalable files in the cache memory is provided in order to free up storage space.

2. The cache device as claimed in claim 1, wherein the scalable files are media files, video files or audio files, each comprising information packets of a basic information level and information packets of a non-basic information level wherein the non-basic information levels are extension information levels which comprise information regarding extended resolution, extended quality and/or an extended component.

3. The cache device as claimed in claim 1, wherein in accordance with the displacement strategy, freeing up of storage space is effected such that storage occupancy by any of the information packets of a non-basic information level of the scalable file is freed up, and storage occupancy by an information packet of a basic information level of the same scalable file is preserved.

4. The cache device as claimed in claim 2, wherein in accordance with the displacement strategy, freeing up of storage space is effected such that storage occupancy by an information packet which comprises information of a most detailed extension information level is freed up.

5. The cache device as claimed in claim 2, wherein in accordance with the displacement strategy, freeing up of storage space is effected such that the extended resolution is reduced down to a predefined fraction of an original resolution once the extended quality has been reduced down to a predefined fraction of an original quality, or that the extended quality is reduced down to a predefined fraction of an original quality once the extended resolution has been reduced down to a predefined fraction of an original resolution.

6. The cache device as claimed in claim 2, wherein in accordance with the displacement strategy, freeing up of storage space is effected such that the extended quality and the extended resolution are simultaneously reduced down to a minimum value of an original quality and of an original resolution.

7. The cache device as claimed in claim 1, wherein in accordance with the displacement strategy, freeing up of storage space is effected such that storage occupancy by an empty information packet is freed up.

8. The cache device as claimed in claim 1, wherein in accordance with the displacement strategy, freeing up of storage space is effected such that storage occupancy by an incompletely stored information packet is freed up.

9. The cache device as claimed in claim 1, wherein in accordance with the displacement strategy, freeing up of storage space is effected such that storage occupancy by an information packet of a non-basic information level is freed up in dependence on a size of a storage location taken up.

10. The cache device as claimed in claim 9, wherein in accordance with the displacement strategy, freeing up of storage space is effected such that the storage occupancy by the largest information packet of a non-basic information level is freed up.

11. The cache device as claimed in claim 9, wherein in accordance with the displacement strategy, freeing up of storage space is effected such that the storage occupancy by the largest stored information packet is freed up.

12. The cache device as claimed in claim 9, wherein in accordance with the displacement strategy, freeing up of storage space is effected such that the storage occupancy by the information packet which occupies the most storage space for a respective frame is freed up.

13. The cache device as claimed in claim 9, wherein in accordance with the displacement strategy, freeing up of storage space is effected such that the storage occupancy by that information packet which is large enough, with regard to the storage space taken up, that it may be reloaded within a predefined time window at an available readout speed and may consequently be sent to the caller completely is freed up.

14. The cache device as claimed in claim 1, configured to log a freeing-up status which indicates freed-up storage occupancies.

15. The cache device as claimed in claim 1, the cache device being connected to a proxy file generator configured to produce a proxy file in the cache memory in such a manner that the proxy file is transferable into a structure of its own account, or directly comprises said structure, which corresponds to a further structure of files to be cached,
the proxy file generator further being configured to read out a first information packet of a basic information level from the file to be cached and to insert it into the proxy file at a position specified by the second structure, and to output the proxy file in the second structure, so that in the second structure, at least one of the information packets of a non-basic information level is replaced with an empty information packet.

16. The cache device as claimed in claim 1, configured to output the one or more scalable files in such a manner that a structure of the scalable file corresponds to a structure of a file to be cached.

17. The cache device as claimed in claim 16, configured to replace, during output of the one or more scalable files, one or more discarded information packets with one or more empty information packets, so that the one or more scalable files are output in accordance with the structure of the files to be cached.

18. The cache device as claimed in claim 1, wherein the cache memory comprises a first interface, by means of which the cache memory is connectable to a mass storage on which the files to be cached are stored; and
wherein the cache memory comprises a second interface, by means of which the cache memory is connectable to a processor or a decoder.

19. The cache device as claimed in claim 1, the cache device exhibiting a further displacement strategy wherein storage occupancy by that file which was the first to be cached is freed up, and/or wherein storage occupancy by that file which has not been accessed for the longest period of time is freed up, and/or wherein storage occupancy by that file which has been least frequently accessed is freed up.

20. A method of managing a cache memory of a cache device, comprising:
freeing up storage space in accordance with a displacement strategy, in accordance with which scaling-down of one or more scalable files in the cache memory is provided for caching.

21. A computer program comprising a program code for performing the method of managing a cache memory of a cache device, said method comprising:
freeing up storage space in accordance with a displacement strategy, in accordance with which scaling-down of one or more scalable files in the cache memory is provided for caching,
when the program runs on a computer.
